(19) United States
(12) Patent Application Publication
(10) Pub. No.: US 2005/0195476 A1
(43) Pub. Date: Sep. 8, 2005

(54) Anti-counterfeiting system for movie theaters

(76) Inventor: David Bogart Dort, Washington, DC (US)

Correspondence Address: TIGHE PATTON ARMSTRONG TEASDALE PLLC, BOX 27519, WASHINGTON, DC, 20038-7519, US

(21) Appl. No.: 10/794,678

(22) Filed: Mar. 5, 2004

(51) Int. Cl. G03B 21/56

(52) U.S. Cl. 359/443

(57) ABSTRACT

In order to protect movies being shown in theaters from being taped illicitly by sophisticated digital video cameras, the invention places a translucent layer of material between the camera and the screen, or, in the alternative a “barrier” of light (or non-visible light), neither of which is undetectable to a human movie viewer, but which has an optical property (usually including polarization) such that it impairs the image taken by the digital movie camera. The “lens” variations between an eye and a digital camera can be exploited by the invention by placing the barrier an optically desired distance from the actual screen in order to prevent illicit taping. In certain embodiment the translucent layer is illuminated from target angle including directly into the material at a normal angle.

### BACKGROUND

Referring now to FIG. 5, the problem of “counterfeiting” movies by videotaping the movie in the theater has been increasing. Although the reproduction quality is inferior in every way there are other reasons film distributors and studios do not want “bootlegged” copies to be distributed into the public.

### SUMMARY

The prevent invention uses the difference in optical properties between the human eye (viewer) and a recording camera lens (camera) to prevent the recording of a movie in a theater by placing a physical layer of translucent material a target distance in front of a movie screen without impairing the viewers' enjoyment of the movie. A virtual system in which light emanating from strategically placed devices also prevents the recording of the movie with a camera without impairing the viewer experience.

### BRIEF DESCRIPTION OF THE DRAWINGS

The invention can be better understood by reference to the following diagrams in which:

FIG. 1 shows a first embodiment of the invention with a physical anti-recording or counterfeiting layer;

FIG. 2 shows a second embodiment of the invention with the virtual anti-counterfeiting mechanism;

FIG. 3 illustrates the preferred embodiment of the invention in which a virtual anti-counterfeiting layer;

FIG. 4 shows a functional view of the invention;

FIG. 5 illustrates the problem of counterfeiting by recording a movie in a theater with a video camera;

FIG. 6 represents one possible functional equivalent of the invention;

FIG. 7 represents an alternate embodiment of the invention in which the anti-counterfeit projecting devices are placed to create to virtual anti-counterfeiting layers;

FIG. 8 represents an alternate configuration of the invention in which a portion of a movie screen is blocked off.

### DETAILED DESCRIPTION

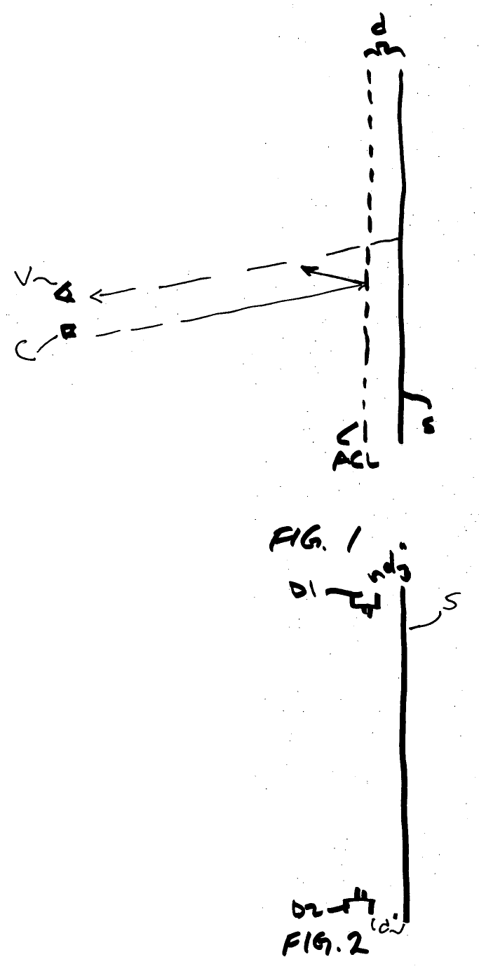

Referring now to FIG. 1, a first embodiment of the invention is shown in which a physical anti-counterfeiting or anti-recording layer ACL is shown in front of the screen S. The operation of the invention is based on the principle that an eye functions as one type of lens for the viewer V, but the camera lens C is subject to another set of optical principles in order to record what is taking place on the screen. One operational principle is analogous to the scenario shown in FIG. 6, in which a viewer looks through a space into a dark area, which appears to be invisible and then to a lighted area beyond where the object is located. The use of the “virtual image” can be used to prevent a standard lens system from recording the object in the distance.

Thus, the physical anti-counterfeiting layer ACL can be made of any type of translucent material, such as glass, film or plastic, with appropriate polarization as would be appropriate and determined by the skilled artisan to prevent the optical properties of the camera lens from making a decent reproduction of the film, while being invisible to the human eye. The ACL will be a distance d from the screen S in order to create the desired effect in the camera lens C without affecting the viewer's V enjoyment of the movie.

Referring now to FIG. 2 a second configuration of the invention is shown using virtual anti-counterfeiting devices D1 and D2, strategically placed a distance d′ in front of the screen S.

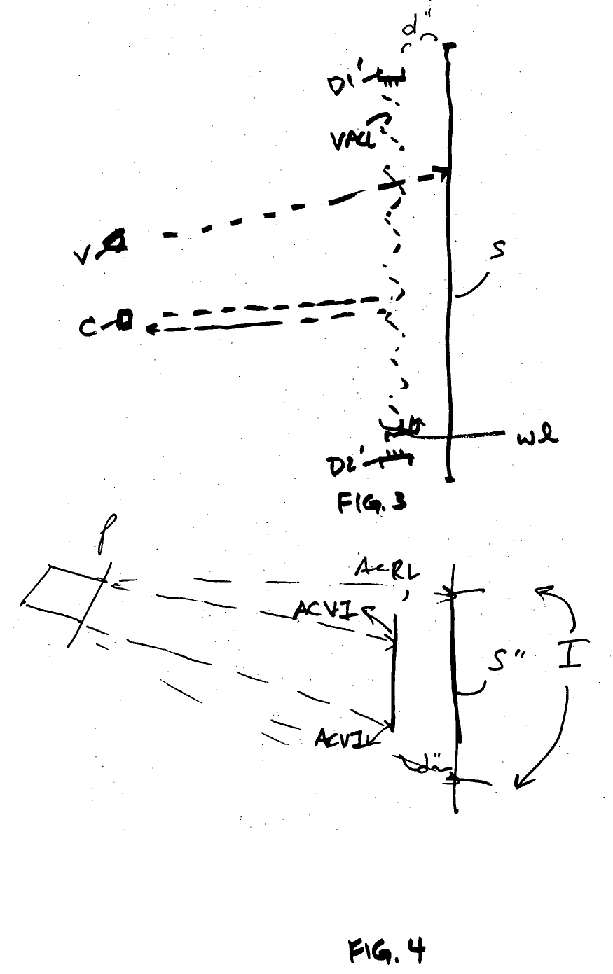

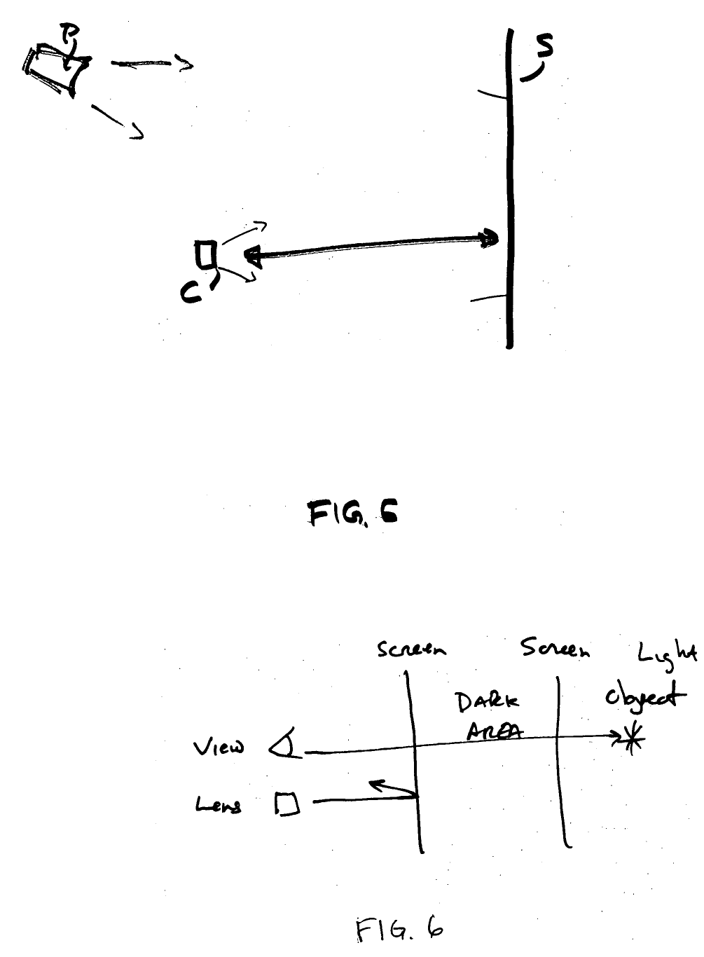

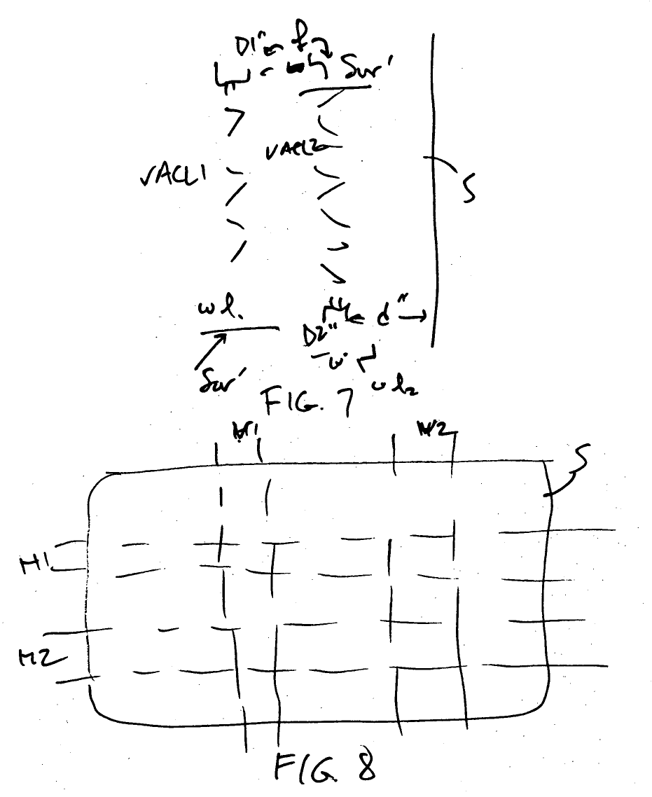

Referring now to FIG. 3, a virtual implementation of the embodiment shown in FIG. 2 in which the virtual anti-counterfeiting devices D1 and D2 are active by creating a virtual anti-counterfeiting layer of electromagnetic energy, most likely light at the barely visible end of the spectrum, or other types of light that would not be clearly visible to viewer V, but prevent the camera lens C from obtaining a quality picture of the screen S. The virtual anti-counter fitting layer of light VACL is an appropriate width w(l) and distance from the screen to create the desired effect of not interfering with the viewer's enjoyment of the movie. The anti-counterfeiting devices D1′ and D2′ may interact with each other in a temporal fashion or being projected into space or a reflective surface (see FIG. 7). Any number of anti-counterfeiting devices may be used from various optical angles as would be needed to implement the invention.

Referring now to FIG. 7, an alternate embodiment of that shown in FIG. 3 in which the two anti-counterfeiting devices D1″ and D2″ are set apart a distance h to improve the anti-counterfeiting effect and creating no impediment to the viewer. Each VACL has a width wl(1) and wl(2) and the distance d″ from the screen is determined by the necessary parameters of the movie theater. Each of D1″ and D2″ may reflect its VACL into space or against an appropriate surface Sur′ in which the optical conditions are created that prevent the use of a video camera.

Referring now to FIG. 4, a functional diagram of the invention is shown in which the projector P projects an image I onto the screen either in a traditional theater or from behind the screen in an alternate system. The Projector also projects an image not seen by the viewers against a Anti-counterfeiting reflective layer ACRL which creates a anti-counterfeiting virtual image ACVI which is recorded by the camera and does not reproduce such that it is any benefit to counterfeiters.

One of the advantages of the virtual anti-counterfeiting system is that movie theaters may implement the invention without attempting to cover the screen. However, as opposed to FIG. 1, another embodiment as shown in FIG. 8 only requires a portion of the screen to be covered by sample vertical anti-counterfeit strips V1 and V2 and horizontal counterfeit blockers H1 and H2, which create an impaired recording on the camera. However, the impaired recording may not accomplish the objectives of the studio which may be secrecy of content or other concepts which are kept from public view for business purposes.

Only a few of the embodiments of the invention have been detailed above for illustration purposes only. As can be appreciated there are other ways within the spirit and scope of the invention to accomplish the anti-counterfeiting/anti-recording feature without disturbing the viewer's experience of the movie.

1. An anti-recording system for a movie theater including a layer of transparent material placed a target distance in front of at least part of said a movie screen that allows a viewer to see the image on the screen unimpaired, wherein said image recorded by a camera lens will not reproduce properly due to the optical properties of said transparent material.

2. An anti-recording system for a movie theater including devices located a target distance in front of a movie screen that project light in a target direction, said projected light preventing the recording of an image on said movie screen, said light not interfering with a viewer's observation of said image.

3. A method for preventing the recording of a image on a movie screen including the acts of:
determining a target distance in front of said movie screen;
placing a physical or virtual barrier said target distance in front of said movie screen, such that an image located on said movie screen cannot be accurately be reproduced by a camera operating in a dark theater;
wherein a viewer's observation of said image in said dark theater is not impaired.
